(19) United States
(12) Patent Application Publication
(10) Pub. No.: US 2009/0084852 A1
(43) Pub. Date: Apr. 2, 2009

(54) Aiming pattern indicative of optimum working distance in imaging reader and method

(76) Inventors: Igor Vinogradov, New York, NY (US); Edward Barkan, Miller Place, NY (US); Mark Drzymala, Commack, NY (US); Vladimir Gurevich, Stony Brook, NY (US)

Correspondence Address: KIRSCHSTEIN, ISRAEL, SCHIFFMILLER & PIERONI, P.C., 425 Fifth Avenue, 5TH FLOOR, New York, NY, 10016-2223, US

(21) Appl. No.: 11/906,091

(22) Filed: Sep. 28, 2007

(51) Int. Cl. G06K 7/10

(52) U.S. Cl. 235/462.21

(57) ABSTRACT

An aiming light assembly supported by a mobile imaging reader projects an aiming light pattern on a symbol prior to reading. The aiming light pattern visually indicates to an operator an optimum distance in a working range at which the symbol is best readable within a field of view.

### BACKGROUND OF THE INVENTION

Solid-state imaging readers have been used in supermarkets, warehouse clubs, department stores, and other kinds of retailers to electro-optically read one-dimensional bar code symbols, particularly of the Universal Product Code (UPC) type, on products to be purchased, each symbol having a row of bars and spaces spaced apart along one direction, and also for processing two-dimensional symbols, such as Code 49, on such products, as well as other items. The structure of Code 49, which introduced the concept of vertically stacking a plurality of rows of bar and space patterns in a single symbol, is described in U.S. Pat. No. 4,794,239. Another two-dimensional code structure for increasing the amount of data that can be represented or stored on a given amount of surface area is known as PDF417 and is described in U.S. Pat. No. 5,304,786.

A typical imaging reader has a one- or two-dimensional array of cells or photosensors, which correspond to image elements or pixels in a field of view of the array, and is similar to that used in a digital camera. The array may be a one- or two-dimensional charge coupled device (CCD) or a complementary metal oxide semiconductor (CMOS) device, together with associated circuits for producing electronic signals corresponding to a one- or two-dimensional array of pixel information over the field of view. A microprocessor is used to analyze and decode the captured image of the symbol. The array may be used for capturing a monochrome image of a symbol as, for example, disclosed in U.S. Pat. No. 5,703,349. The array may have multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

Yet, the use of imaging readers, especially hand-held movable readers, for reading symbols located anywhere within a range of working distances relative to the readers has proven to be challenging. An operator cannot see exactly whether a symbol is within the field of view of the array during reading, or know whether the symbol is located at an optimum distance for best reading within the working range. The symbol must lay preferably entirely within the field of view, as well as at an optimum distance within the working range, to be successfully and rapidly decoded and read. It is not uncommon for the operator to repeatedly move the portable reader in multiple side-to-side, up-and-down, and back-and-forth, directions and repeatedly aim the portable reader at a single symbol several times before an indicator advises the operator that the symbol has been successfully read, thereby slowing down transaction processing and reducing productivity.

This blind aiming at the symbol is easier if the symbol is relatively small or is far away from the reader, because then the chances that the symbol will lay within the field of view are greater. However, in most cases, this blind aiming at the symbol is difficult to overcome, especially when the position and orientation of the symbol are variable.

To help overcome this blind aiming problem, an aiming light arrangement is typically mounted in the reader, for projecting a visible aiming light pattern to visually target the symbol within the field of view and, thus, advise the operator which way the reader is to be moved in order to position the aiming light pattern on the symbol, typically at the center thereof, prior to reading. As advantageous as such aiming light arrangements are, they have proven to be less than satisfactory in certain situations. For example, the aiming light pattern does not typically provide information about how far from, or close to, the reader the symbol should be located for best reading performance. The aiming light pattern typically indicates the overall size of the field of view, but does not guide the operator to the best distance for reading.

Reading performance can often be also less than satisfactory when the resolution of the array is low, e.g., when the number of pixels in the array is below one million, and when the depth of focus of an imaging lens associated with the array is limited, e.g., less than a few inches, especially when symbols of high density, such as the two-dimensional PDF417 symbol described above, need to be read. Reading performance is limited by the number of pixels in the array per each module (PPM) of the symbol. A module is the narrowest or smallest dimension of an element, e.g., a dark or lighter area, of a symbol to be resolved and read. A module can be on the order of five mils in size for the PDF417 symbol commonly printed on a driver's license for personal identification. The PPM becomes a limiting factor in reading, especially when the symbol is located far from the reader.

### SUMMARY OF THE INVENTION

One feature of the present invention resides, briefly stated, in a reader for, and a method of, electro-optically reading a symbol, especially a two-dimensional symbol, located in a range of working distance from the reader. The reader is preferably embodied as a portable, point-of-transaction, gun-shaped, hand-held housing, but could be embodied as a hand-held, box-shaped housing, or the like. Prior to reading of the symbols, the reader is brought to, and aimed at, the symbols by an operator. In the preferred embodiment, the reader is installed in a retail establishment, such as a supermarket, but can be installed virtually anywhere requiring symbols to be read.

A two-dimensional, solid-state imager under control of a controller is mounted in the reader, and includes an array of image sensors operative for capturing light from the two-dimensional symbol over a field of view, and for generating an electrical signal indicative of the captured light. The field of view of the imager diverges in an outward direction away from the imager. Preferably, the array is a charge coupled device (CCD) or a complementary metal oxide semiconductor (CMOS) array. An imaging lens is preferably mounted in the reader in front of the imager to focus the captured light onto the imager. The imaging lens causes the field of view to rapidly widen at a steeper angle of divergence.

The imager may be associated with a high-speed strobe illuminator under control of the controller to enable the image of the symbol to be acquired in a very short period of time, for example, on the order of 500 microseconds, so that the symbol image is not blurred even if there is relative motion between the imager and the symbol. The strobe illumination is preferably brighter than ambient illumination. The illumination can also be continuous. The imager captures light over an exposure time period, also under the control of the controller. A short exposure time also prevents image blurring. The controller is also operative for processing the electrical signal into data indicative of the symbol being read.

In accordance with one feature of this invention, an aiming light assembly is supported by the housing and operatively connected to the controller, and is operative for projecting on the symbol, prior to reading, an aiming light pattern that visually indicates to the operator an optimum distance in the working range at which the symbol is readable within the field of view. Thus, the operator is visually guided to the best distance for reading.

In a preferred embodiment, the symbol is applied on a target having a fixed width, as considered along a longitudinal direction. Preferably, the target is a driver's license, and the symbol is a high density, two-dimensional PDF417 symbol printed on the license. The overall size of a driver's license is standardized throughout most, if not all, of the states of the United States to be eighty-six millimeters in width and fifty-four millimeters in height. The overall size of the symbol on the license may vary from state to state; however, it cannot be larger than the width of the license. According to one aspect of this invention, the aiming light pattern has a width matching the fixed width of the license at the optimum or best distance in the working range for resolving the smallest module or feature of the symbol. Hence, the symbol is read reliably and quickly, capitalizing on the fact that the width of the license is fixed at a known size. In a retail setting, reading a driver's license verifies one's age and, hence, is a requirement for checking whether one is old enough to purchase tobacco and alcoholic products.

The aiming light assembly preferably includes one or a plurality of light sources and one or a plurality of pattern shaping optical elements, such as diffractive or refractive optical elements. One or each light source is advantageously a laser. The aiming light pattern advantageously, but not necessarily, includes light markers spaced apart along the longitudinal direction and located at opposite end regions of the symbol at the optimum distance. If the distance of the symbol is not at the optimum distance, then the markers are located either off the license (indicating that the symbol is too far from the reader), or close together within the symbol (indicating that the symbol is too close to the reader). At the optimum distance, there is sufficient resolution, i.e., enough PPM, for a successful reading, and the imaging lens delivers its sharpest image to the array.

The method of electro-optically reading symbols located in a range of working distances from a reader advantageously comprises the steps of moving a housing by an operator; capturing light over a field of view from a symbol, and generating an electrical signal indicative of the captured light; processing the electrical signal into data indicative of the symbol being read; and projecting on the symbol, prior to reading, an aiming light pattern that visually indicates to the operator an optimum distance in the working range at which the symbol is readable within the field of view.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of an imaging reader for electro-optically reading symbols by image capture in accordance with this invention;

FIG. 2 is a diagrammatic plan view of components within the reader of FIG. 1 including components of an aiming light arrangement;

FIG. 3 is an elevational view of a driver's license on which is printed a two-dimensional symbol illuminated by the aiming light arrangement of FIG. 2 at an optimum working distance prior to reading;

FIG. 4 is a view analogous to FIG. 3, but with the symbol illuminated at a close-in distance less than the optimum working distance; and

FIG. 5 is a view analogous to FIG. 3, but with the symbol illuminated at a far-out distance greater than the optimum working distance.

### DETAILED DESCRIPTION OF THE PREFERRED EMBODIMENTS

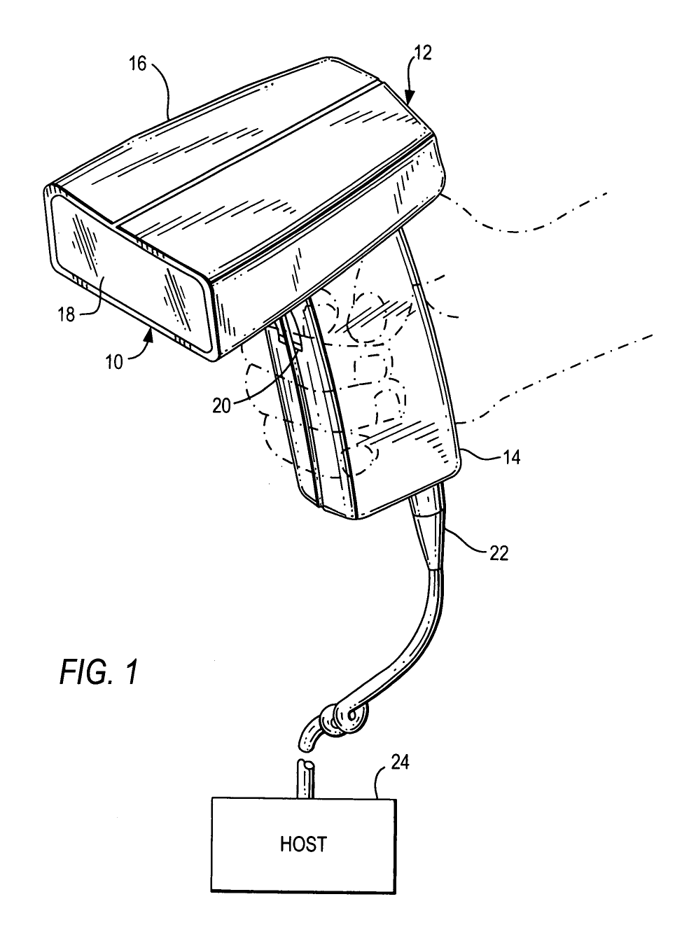

Reference numeral 10 in FIG. 1 generally identifies a hand-held imaging reader for electro-optically reading symbols or like indicia on products or like targets. The reader 10 includes a housing 12 in which an aiming light assembly, as described in detail below in accordance with this invention, is incorporated. The housing 12 includes a generally elongated handle or lower handgrip portion 14 and a barrel or upper body portion 16 having a front end at which a light-transmissive window 18 is located. The cross-sectional dimensions and overall size of the handle are such that the reader can conveniently be held in an operator's hand.

The body and handle portions may be constructed of a lightweight, resilient, shock-resistant, self-supporting material such as a synthetic plastic material. The plastic housing may be injection molded, but can be vacuum-formed or blow-molded to form a thin hollow shell which bounds an interior space whose volume is sufficient to contain the various components of this invention.

A manually actuatable trigger 20 is mounted in a moving relationship on the handle 14 in a forward facing region of the reader. The operator's forefinger is used to actuate the reader to initiate reading by depressing the trigger. An optional flexible electrical cable 22 is provided to connect the reader to a remote host 24. The cable may also provide electrical power to the reader. The host 24 has access to a database for retrieval of information. If the cable 22 is not used, then a wireless link to transfer data may be provided between the reader 10 and the host 24, and an on-board battery, typically within the handle, can be used to supply electrical power.

An alternative embodiment incorporates a display and a keyboard. Data obtained from reading the symbols is then either transferred to the remote host 24 in real time, or saved to an internal memory such that the stored data can be transferred to the host 24 at a later time in batch mode.

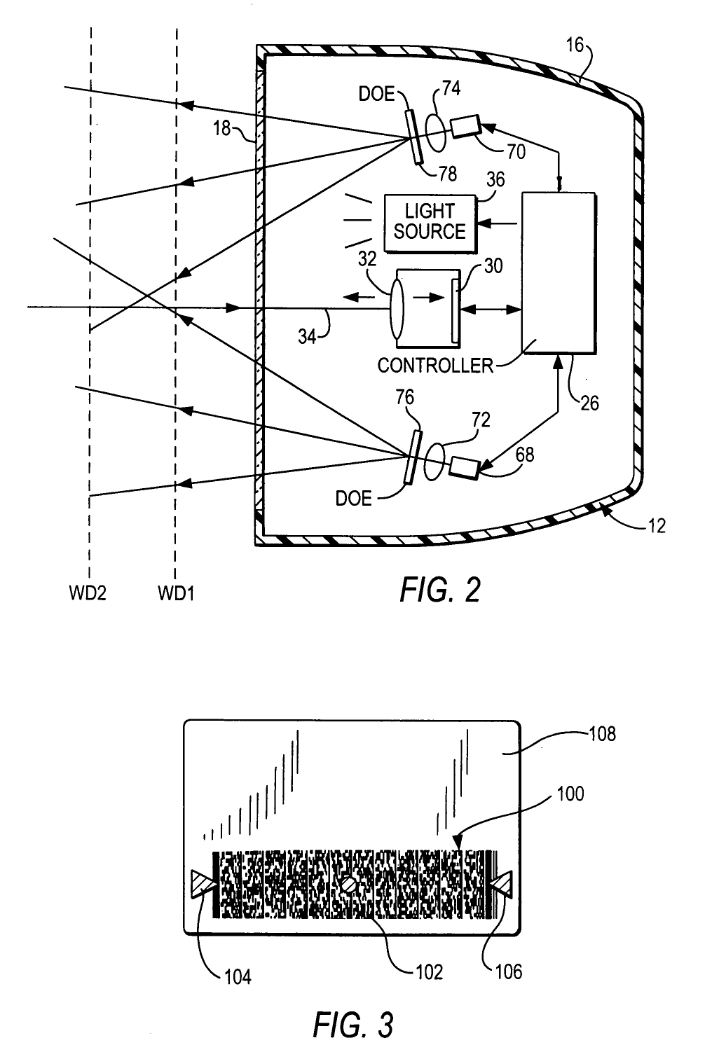

A solid-state imager 30, as shown in the interior plan view of FIG. 2, is mounted within the housing 12 and preferably is a two-dimensional, charge coupled device (CCD) or complementary metal oxide semiconductor (CMOS) array of cells or sensors operative for capturing light over its field of view from a symbol through the window 18 and focused by an imaging lens assembly 32. The sensors produce electrical signals corresponding to a two-dimensional array of pixel information for an image of the symbol. The electrical signals are processed by a controller or microprocessor 26 into data indicative of the symbol being read. The imager 30 and imaging lens assembly 32 are preferably aligned along a centerline or an optical axis 34 generally centrally located within the body portion 16.

As shown in FIG. 2, the imaging lens assembly 32 has a fixed focus and enables image capture over a range of working distances between a close-in distance WD1 and a far-out distance WD2 relative to the window 18. The imager and imaging lens assembly are capable of acquiring a full image of the symbol in lighting conditions from two lux to direct sunlight. Exposure time is about 15 milliseconds and controlled by the controller 26. Resolution of the array can be of various sizes although a VGA resolution of 640×480 pixels is preferred.

An illumination or light source 36 for the imager 30 is also provided to provide an illumination field for the imager. The source 36 preferably constitutes one or a plurality of light emitting diodes energized by power supply lines in the cable 22, or via the on-board battery. The source 36 is preferably pulsed in synchronism with the imager 30 under the control of the controller 26.

As described so far, many operators have difficulty using the described hand-held movable reader, because they cannot see exactly whether the symbol is within the field of view of the imager array 30 during reading, or know whether the symbol is located at an optimum distance for best reading within the working range. The symbol must lay preferably entirely within the field of view, as well as at the optimum distance within the working range, to be successfully and rapidly decoded and read. It is not uncommon for the operator to repeatedly move the portable reader in multiple side-to-side, up-and-down, and back-and-forth, directions and repeatedly aim the portable reader at a single symbol several times before an indicator advises the operator that the symbol has been successfully read, thereby slowing down transaction processing and reducing productivity.

In accordance with one feature of this invention, an aiming light assembly is supported by the housing 12, and is operative for projecting an aiming light pattern, such as light markers 102, 104, and 106, as depicted in FIG. 3, on a symbol, such as a two-dimensional, high density, PDF417 symbol 100 printed on a sheet medium, such as the back of a driver's license 108. Markers 104 and 106 are advantageously formed as inwardly facing arrowheads to bracket opposite end regions of the symbol. Marker 102 is advantageously formed as a generally circular spot or crosshairs for placement at the center of the symbol. Other aiming light patterns for framing the symbol are contemplated.

The aiming light assembly includes one or a plurality of light projectors for projecting the markers 102, 104, and 106 onto the symbol 100. One or each projector includes a light source, such as a laser 68, 70, a focusing lens 72, 74, and a pattern shaping optical element, such as a diffractive optical element (DOE) 76, 78, or a refractive optical element (ROE). The focused light passing through a respective DOE forms multiple diverging beamlets, as described in U.S. Pat. No. 6,340,114, which exit the window 18 and project continuous lines or rows of spots arrayed in a pattern of the respective markers 102, 104, and 106 on the symbol 100.

A detailed analysis of a refractive optical element or lens suitable for use in shaping a laser beam into an aiming light pattern is found in U.S. Patent Publication No. 2005/0284942 A1, published Dec. 29, 2005 (U.S. patent application Ser. No. 10/879,333, filed Jun. 29, 2004) to Gurevich, et al. This published application is assigned to the assignee of the present application and is incorporated herein in its entirety by reference. Another detailed analysis of a diffractive optical element or lens for use in shaping a laser beam is found in U.S. Pat. No. 6,021,106, issued Feb. 1, 2000 to Welch, et al.

Diffractive/refractive optics creates a bright, crisp aiming light pattern which provides ready feedback to the operator regarding the direction in which the housing 12 and, hence, the field of view is to be moved in order to position the symbol entirely within the field of view and at the optimum working distance, as described below. In a preferred embodiment, each laser light source has an output power on the order of 5 milliwatts and a wavelength of 650 nanometers. Instead of diffractive/refractive optics, it is also possible to use masks to project the aiming light pattern onto the symbol.

The aiming light pattern depicted in FIG. 3 visually indicates to the operator the optimum distance in the working range at which the symbol 100 is readable within the field of view. As described above, the overall size of the driver's license 108 is standardized throughout most, if not all, of the states of the United States to be eighty-six millimeters in width and fifty-four millimeters in height. Thus, the license 108 has a fixed width, as considered along a longitudinal direction. The overall size of the symbol 100 on the license 108 may vary from state to state; however, it cannot be larger than the width of the license.

According to one aspect of this invention, the aiming light pattern has a width matching the fixed width of the license at the optimum or best distance in the working range for resolving the smallest module or feature of the symbol. Hence, the symbol is read reliably and quickly, capitalizing on the fact that the width of the license 108 is fixed at a known size. At the optimum distance, there is sufficient resolution, i.e., enough PPM, for a successful reading, and the imaging lens delivers its sharpest image to the array. In a retail setting, reading a driver's license verifies one's age and, hence, is a requirement for checking whether one is old enough to purchase tobacco and alcoholic products.

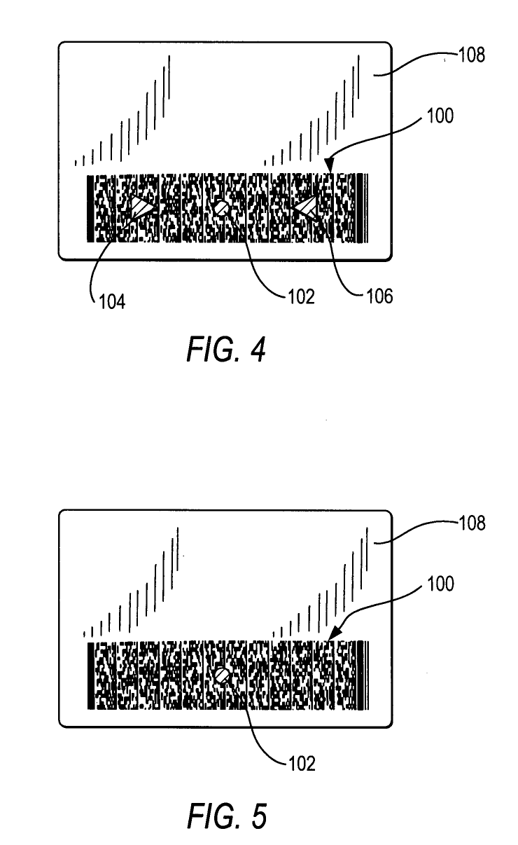

FIG. 4 depicts the situation when the symbol is not at the optimum distance, but is too close to the reader. The markers 104, 106 are located close together within the symbol. FIG. 5 depicts the situation when the symbol is not at the optimum distance, but is too far from the reader. The markers 104, 106 fall off the license.

In use, the operator points the reader 10 at the symbol 100 to be read and manually depresses the trigger 20 to initiate reading. The controller 26 activates the imager 30 and the aiming lasers 68, 70 to project the aiming light pattern on the symbol. If the operator sees that the pattern is like that shown in FIG. 4, then the operator will move the reader away from the symbol. If the operator sees that the pattern is like that shown in FIG. 5, then the operator will move the reader closer to the symbol. Once the symbol is entirely within the field of view and at the optimum distance as shown in FIG. 3, then the controller 26 activates the illumination source 36, and the illuminated symbol can be successfully decoded by the controller 26, and an indicator will so advise the operator. Preferably, each aiming laser 68, 70 is deactivated during the reading of the symbol.

The aiming light assembly is typically physically offset from the imager in a direction generally perpendicular to an optical axis of the imager. Because the aiming light assembly is not coaxially aligned with the imager in the reader housing, this results in parallax between the field of view of the imager and the aiming light pattern. Parallax may prevent a successful imaging and reading of the symbol. However, at the optimum distance described above, a center of the aiming light pattern and a center of the field of view of the imager are congruent, or nearly so, and, hence, the deleterious effect of parallax on symbol reading is minimized, if not eliminated.

It will be understood that each of the elements described above, or two or more together, also may find a useful application in other types of constructions differing from the types described above. Thus, readers having different configurations can be used. Also, different aiming patterns can be employed.

While the invention has been illustrated and described as employing an aiming light pattern projected from an imaging reader to indicate an optimum distance at which to read symbols, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. A reader for electro-optically reading 'symbols located in a working range of distances from the reader, comprising:
a housing movable by an operator;
a solid-state imager supported by the housing, for capturing light over a field of view from a symbol, and for generating an electrical signal indicative of the captured light;
a controller supported by the housing, for processing the electrical signal into data indicative of the symbol being read; and
an aiming light assembly supported by the housing and operatively connected to the controller, for projecting on the symbol, prior to reading, an aiming light pattern that visually indicates to the operator an optimum distance in the working range at which the symbol is readable within the field of view.

2. The reader of claim 1, wherein the symbol is applied on a target having a fixed width, as considered along a longitudinal direction.

3. The reader of claim 2, wherein the target is a driver's license, and wherein the symbol is a two-dimensional symbol printed on the license.

4. The reader of claim 2, wherein the fixed width is eighty-six millimeters.

5. The reader of claim 2, wherein the aiming light pattern has a width at the optimum distance that corresponds to the fixed width of the target.

6. The reader of claim 1, wherein the aiming light assembly includes a light source and a pattern shaping optical element.

7. The reader of claim 6, wherein the light source is a laser, and wherein the pattern shaping optical element is one of a diffractive and a refractive optical element.

8. The reader of claim 2, wherein the aiming light pattern includes light markers spaced apart along the longitudinal direction at opposite end regions of the symbol at the optimum distance.

9. The reader of claim 1, wherein the imager is one of a charge coupled device and a complementary metal oxide silicon device, and wherein the symbol is a high density two-dimensional symbol.

10. A reader for electro-optically reading symbols located in a working range of distances from the reader, comprising:
housing means movable by an operator;
imaging means supported by the housing means, for capturing light over a field of view from a symbol, and for generating an electrical signal indicative of the captured light;
control means supported by the housing means, for processing the electrical signal into data indicative of the symbol being read; and
aiming means supported by the housing means and operatively connected to the control means, for projecting on the symbol, prior to reading, an aiming light pattern that visually indicates to the operator an optimum distance in the working range at which the symbol is readable within the field of view.

11. An arrangement for aiming at symbols to be electro-optically read by a reader in a working range of distances from the reader, comprising:
a movable solid-state imager for capturing light over a field of view from a symbol, and for generating an electrical signal indicative of the captured light;
a controller for processing the electrical signal into data indicative of the symbol being read; and
an aiming light assembly operatively connected to the controller, for projecting on the symbol, prior to reading, an aiming light pattern that visually indicates to the operator an optimum distance in the working range at which the symbol is readable within the field of view.

12. The arrangement of claim 11, wherein the symbol is applied on a target having a fixed width, as considered along a longitudinal direction.

13. The arrangement of claim 12, wherein the aiming light pattern has a width at the optimum distance that corresponds to the fixed width of the target.

14. A method of electro-optically reading symbols located in a working range of distances from a reader, comprising the steps of:
moving a housing by an operator;
capturing light over a field of view from a symbol, and generating an electrical signal indicative of the captured light;
processing the electrical signal into data indicative of the symbol being read; and
projecting on the symbol, prior to reading, an aiming light pattern that visually indicates to the operator an optimum distance in the working range at which the symbol is readable within the field of view.

15. The method of claim 14, and applying the symbol on a target having a fixed width, as considered along a longitudinal direction.

16. The method of claim 15, and configuring the target as a driver's license, and printing the symbol as a two-dimensional symbol on the license.

17. The method of claim 15, and configuring the fixed width as eighty-six millimeters.

18. The method of claim 15, and configuring the aiming light pattern with a width at the optimum distance that corresponds to the fixed width of the target.

19. The method of claim 14, wherein the projecting step is performed by a light source and a pattern shaping optical element.

20. The method of claim 19, and configuring the light source as a laser, and configuring the pattern shaping optical element as one of a diffractive and a refractive optical element.

21. The method of claim 15, and configuring the aiming light pattern with light markers spaced apart along the longitudinal direction at opposite end regions of the symbol at the optimum distance.

22. The method of claim 14, and configuring the imager as one of a charge coupled device and a complementary metal oxide silicon device, and configuring the symbol as a high density two-dimensional symbol.

23. A method of aiming at symbols to be electro-optically read by a reader in a working range of distances from the reader, comprising the steps of:
capturing light over a field of view from a symbol, and generating an electrical signal indicative of the captured light;
processing the electrical signal into data indicative of the symbol being read; and
projecting on the symbol, prior to reading, an aiming light pattern that visually indicates to the operator an optimum distance in the working range at which the symbol is readable within the field of view.
